(19) United States
(12) Patent Application Publication
(10) Pub. No.: US 2011/0054681 A1
(43) Pub. Date: Mar. 3, 2011

(54) ROBOT

(75) Inventors: Azusa AMINO, Hitachinaka (JP); Saku EGAWA, Toride (JP); Ryosuke NAKAMURA, Hitachinaka (JP)

(73) Assignee: HITACHI, LTD., Tokyo (JP)

(21) Appl. No.: 12/852,554

(22) Filed: Aug. 9, 2010

(30) Foreign Application Priority Data
Aug. 28, 2009 (JP) 2009-197570

(51) Int. Cl. B25J 5/00

(52) U.S. Cl. 700/245; 180/8.3

(57) ABSTRACT

A robot, having left and right leg portions on a lower portion of a body, each of the legs has a wheel attached at a tip of the leg portion, to be drivable, a suspension having a spring and a dumper attached in parallel, between the wheel and the body, and an actuator attached between the suspension and the body. The suspension and the actuator are connected in series, and an inclination detecting means mounted on the body detects an inclination angle and an angular velocity of the robot with respect to a direction of gravity. A control instruction value outputting means controls the actuator upon basis of information thereof, so that the robot travels along a target angle and a target angular velocity thereof. The, spring is connected with an actuator expanding and constructing up and down, in series.

This application relates to and claims priority from Japanese Patent Application No. 2009-197570 filed on Aug. 28, 2009, the entire disclosure of which is incorporated herein by reference.

### BACKGROUND OF THE INVENTION

The present invention relates to a robot, and in particular, it relates to a suspension of a foot thereof.

As a technology for absorbing concave/convex on a surface of a traveling road, thereby for traveling with stability, those are already known in the following Patent Documents 1 and 2, for example.

With the method disclosed in the Patent Document 1, with driving a suspension member by an actuator, in such that a reaction is generated against an input from the road surface, thereby the input having a high frequency, such as, the concave/convex on the road surface, for example, is reduced to be applied thereon.

Also, in the Patent Document 2, for the purpose of controlling a position of gravity with respect to a centrifugal force during the time when it corners, there is disclosed an inverted pendium mechanism having a magnetic floating slider on a truck equipped with a driving mechanism thereon.

### PRIOR ART DOCUMENTS

### Patent Documents

### Brief Summary of the Invention

[Patent Document 1] Japanese Patent Laying-Open No. H07-276955 (1995).

[Patent Document 2] Japanese Patent Laying-Open No. 2005-075070 (2005).

For a robot carrying out an inverted pendium movement with appropriately controlling wheels attached at tips of leg portion, which are provided by two (2) pieces at the left-hand and right-hand sides on a lower portion of a body thereof, it is important to absorb the concave/convex on a surface of road, thereby to run with stability.

For this, there can be considered a means of loading suspensions on the leg portions, but for carrying out the inverted pendium movement, it is necessary to bring the gravity center thereof to be high, and further, to set a spring constant to be small for absorbing the concave/convex on the surface of road.

Also, for making a footprint thereof small, it is necessary to set width between the wheels separating on both sides. For this reason, due to disturbances, such as, a centrifugal force during the time when cornering, the concave/convex on the road surface, and an inclination of the road surface, etc., the left-hand side and the right-hand side are unbalanced in an amount of sinking of the suspension, therefore a swing is generated in a rolling direction (see FIG. 10); i.e., there is a drawback that a possibility of turnover thereof becomes high, and then a stability is lost.

With the method disclosed in the Patent Document 1, since suspension member are driven by actuators in such a manner that a reaction of an input from the road surface can be generated, then it is possible to deal with an input having high frequency, such as, the concave/convex on the road surface, for example, but it is impossible to deal with a n input having a low frequency, such as, an inclination of the road surface.

Also, in the Patent Document 2 is disclosed a inverted pendium movement mechanism having a magnetically floated slider on a truck having the driving mechanism thereon, for controlling a position of the gravity center thereof, with respect to the centrifugal force during the time when cornering; however, it is not enough for an input having high frequency, such as, the concave/convex on the road surface, for example.

An object of the present invention is to provide a leg portion suspension for a robot, having two (2) sets of leg portions on both sides, in a lower portion of a body, and enabling to run on the wheels, with stability, on the concave/convex on the road surface, with controlling the wheels, which are provided at tips of those leg portions.

The object mentioned above is accomplished by a robot, having left and right leg portions on a lower portion of a body, each of the legs comprising: a wheel attached at a tip of said leg portion, to be drivable; a suspension having a spring and a dumper, being attached in parallel, between said wheel and said body; and an actuator, being attached between said suspension and said body, wherein said suspension and said actuator are connected in series, and an inclination detecting means mounted on said body detects an inclination angle and an angular velocity of said robot with respect to a direction of gravity, and a control instruction value outputting means controls said actuator upon basis of information thereof, so that said robot travels along a target angle and a target angular velocity thereof.

Also, the object mentioned above is accomplished by the robot, as described in the above, wherein said spring is connected with an actuator expanding and constructing up and down, in series, and said dumper is provided in parallel with said spring and said actuator.

Also, the object mentioned above is accomplished by the robot, as described in the above, further comprising: an actuator for use of said wheel, a lower frame being connected with said actuator, a slide rail being connected with said lower frame, and an upper frame being connected with said slide rail, wherein said actuator is connected with said upper frame, and being constructed with a first arm, being attached at an upper end of said lower frame to be rotatable only around an X-axis upon assumption that a traveling direction of said robot is said X-axis, and at an opposite end in a longitudinal direction thereof being connected with a second arm to be rotatable around said X-axis, said second arm, being connected with said first arm at one end to be rotatable around said X-axis, an opposite end in the longitudinal direction thereof being connected with said spring upper frame to be rotatable around said X-axis, and being connected with said spring at an end portion thereof extending by a predetermined angle, said spring being connected with said second arm at one end thereof, and being connected with said actuator lever at an opposite end in the longitudinal direction thereof, and said actuator lever being connected with said spring at an end thereof and being connected with an output axis of said actuator at an opposite end in the longitudinal direction thereof.

According to the present invention, since it is possible to suppress a rolling on both sides of an upper portion, being generated due to the unbalance on both sides in the amount of sinking of the suspension, because of the disturbances, such as, the centrifugal force during the time when cornering, the concave/convex on the road surface, and the inclination of the road surface, etc., and therefore, it is possible to provide the suspensions for the leg portion of the robot for enabling a stable running thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing the entire structures of a robot, according to an embodiment 1 of the present invention;

FIG. 2 is a view for showing the structures of leg portions of the robot, according to the embodiment 1 of the present invention;

FIG. 3 is a control block diagram of the robot, according to the embodiment 1 of the present invention;

FIG. 4 is a flowchart for showing a control, according to the present invention;

FIG. 5 is a view for showing an actual implementation of the leg portion of the robot, according to the embodiment 1 of the present invention;

FIG. 6 is a view for showing the structures of the leg portion of the robot, according to an embodiment 2 of the present invention;

FIGS. 7A and 7B are views for showing an actual implementation of the leg portion of the robot, according to an embodiment 3 of the present invention;

FIGS. 8A and 8B are views for showing operations of actuators, in the actual implementation of the leg portion of the robot, according to an embodiment 3 of the present invention;

FIG. 9 is a view for showing a relationship of sizes of the robot, according to an embodiment 3 of the present invention; and

FIG. 10 is a view for showing rolling on the conventional robot.

### DETAILED DESCRIPTION OF THE PREFERRED EMBODIMENTS

Hereinafter, embodiments according to the present invention will be fully explained by referring to the attached drawings.

### Embodiment 1

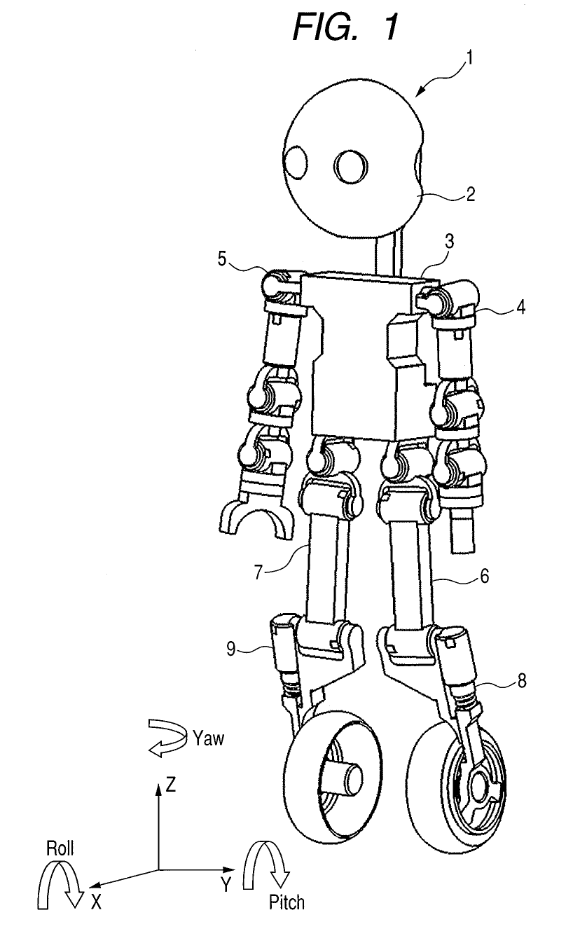

FIG. 1 shows the entire structures of a robot, according to an embodiment of the present invention.

In FIG. 1, a robot 1 according to the present invention has two (2) pieces of leg portions; i.e., a left thigh (a part above the knee) 6 and a left shank (a part below the knee) 8, and a right thigh (a part above the knee) 7 and a right shank (a part below the knee) 9, and a body 3 above those. On both left and right sides are provided two (2) pieces of arm portions; i.e., a left arm 4 and a right arm 5. Also, on an upper part of the body 3 is provided a head portion 2.

For example, the two (2) pieces of leg portions; i.e., the left thigh 6 and the left shank 8 and the right thigh 7 and the right shank 9 are used for movement of the robot 1, and the left arm 4 and the right arm 5 are used for a job, such as, holding of an article, etc. The body 3 comprises therein a controller apparatus for controlling an operation of each part, and sensors for detecting an inclination angle and/or an angular velocity of the body with respect to the direction of gravity.

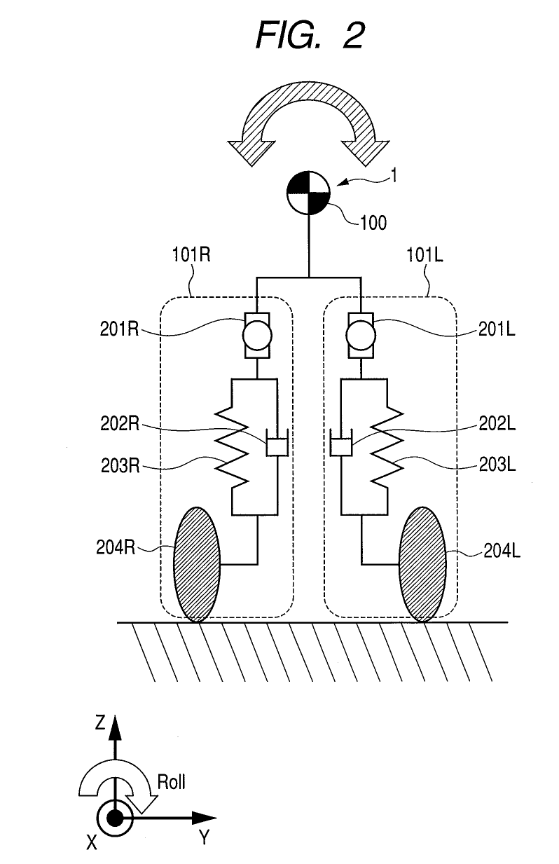

FIG. 2 is a block diagram for showing the left shank 8 and the right shank 9 of the robot 1.

In this FIG. 2, the robot 1 is provided with leg suspensions 101L and 101R in each of the leg portions on both left and right sides, respectively, as is shown in FIG. 2. The leg suspensions 101L and 101R are equal to each other, in the constituent elements thereof, and the structures thereof are symmetric with each other, on an X-Z plane passing through a gravity center 100 of the robot. Accordingly, hereinafter, explanation will be given only the leg suspension 101L.

The leg suspension 101L has a wheel 204L, as is shown in the figure, and on an upper portion thereof is connected a spring 203L and a dumper 202L, in parallel with, and further on an upper portion of thereof is provided an actuator 201L. Herein, the actuator 201L is attached in such a direction that it outputs force in the Z-axis direction.

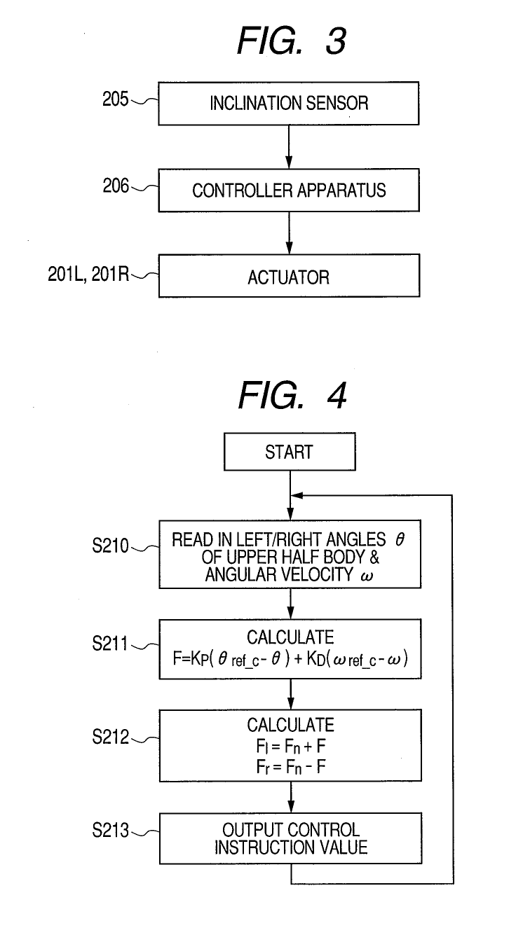

FIG. 3 is a control block diagram according to the present invention.

When the robot shown in FIG. 2 runs on the road surface having concave/convex thereon or on an inclined road surface, or when it receives a centrifugal force during when it corners, vibrations in up/down direction of the robot are absorbed by the springs 203L and 203R and the dumpers 202L and 202R. However, when the left and the right springs 203L and 203R differ in an amount of sinking thereof, an upper body of the robot inclines to a side having the larger sinking, and due to a returning force thereof is generated the rolling or swinging on the left and right sides.

Then, according to the present embodiment, as is shown in FIG. 3, an inclination sensor 205 is mounted on the body 3, so as to detect the inclination angle and the angular velocity of the body 3, with respect to the direction of gravity, with an aid of this inclination sensor 205, while the controller apparatus 206 controls the actuators 201L and 201R, appropriately, upon basis of information detected by the inclination sensor 205, so that the inclination and the angular velocity are coincide with target values thereof.

Each of the actuators 201L and 201R builds stores a source of power or movement (for example, a motor) and a reduction mechanism, and an angular detector (for example, a rotary encoder or a potentiometer) or a position detector (for example, a linear encoder), and it drives the part(s), with which it is connected.

FIG. 4 is a view for showing a controlling flowchart of the robot, according to the present invention.

In FIG. 4, this calculating process is executed at a predetermined sampling time, every ΔT. After starting, firstly an angle θ in direction of left and right sides of the body (herein after, “body left/right angle”) and an angular velocity ω in direction of left and right sides of the body (herein after, “body left/right angular velocity”) from the inclination sensor 301 are read therein, in a step S210. Next, in a step S211, addition is made on a product, obtained by multiplying a predetermined control gain K_{P} on a difference between a body left/right target angle θ_{ref}_{_{—}}_{c} which is given in advance, and the body left/right angle θ, and a product, obtained by multiplying a predetermined control gain K_{D} on a difference between a body left/right target angular velocity ω_{ref}_{_{—}}_{c} which is given in advance, and the body left/right angular velocity ω, thereby calculating a controlling force F. Next, shifting into a step S212, by adding or subtracting a maintenance force Fₙ for supporting a weight of the robot and the controlling force F with each other, a left-leg controlling force F₁ and a right-leg controlling force Fᵣ are calculated, and in a step S213, the left-leg controlling force F₁ and the right-leg controlling force Fᵣ are outputted to the actuators 201L and 201R shown in FIG. 3, respectively.

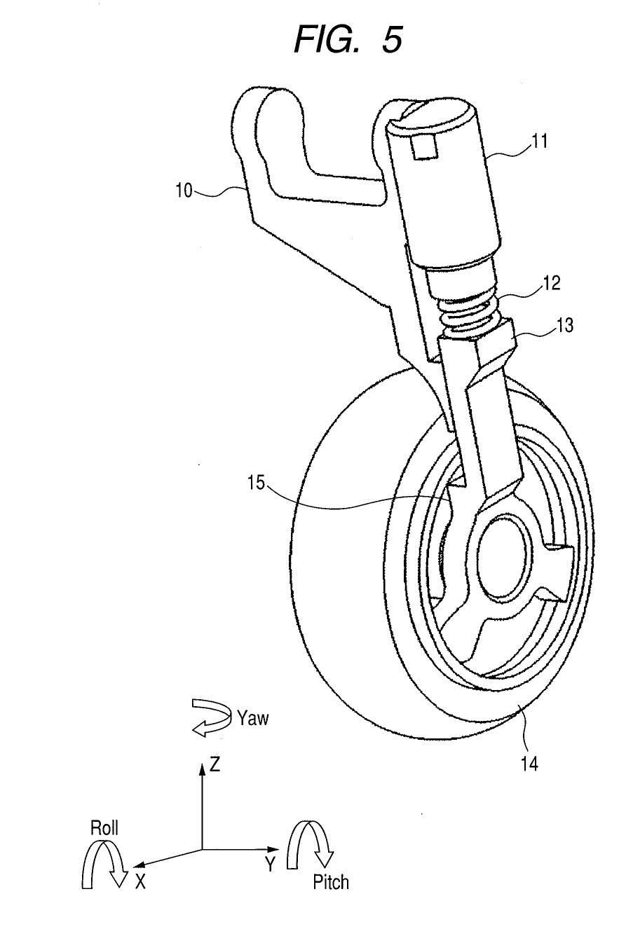

FIG. 5 is a view for showing an actual implementation condition of the left shank 8 of the robot 1, according to the embodiment 1.

In this FIG. 5, the left shank 8 shown in FIG. 1 comprises an actuator 11, which is connected in such a manner that a longitudinal direction of an upper frame 10 of spring and an axis of direction of generating a force are almost in parallel with, a spring/dumper 12, which is connected in such a disposition that it is coincide with an output axis of the actuator 11, a lower frame 13 of spring, which is attached in such manner that it has a degree of freedom of sliding only in the longitudinal direction of the upper frame 10 of spring, a wheel actuator 15 for rotating in a direction of pitch axis in the figure at a lower end in the longitudinal direction of this lower frame 13 of spring, and a wheel 14, which is attached on an output axis of this wheel actuator 15. Herein, at the lower end of the spring/dumper 12 is connected the lower frame 13 of spring.

As was mentioned in the above, according to the present invention, the inclination detecting means mounted on an upper portion detects the inclination angle and the angular velocity thereof with respect to the direction of gravity, with inputting an addition of the force for maintaining a predetermined neutrality and a predetermined control amount, which can be obtained from the inclination and the angular velocity of the upper body, into the actuator provided on the side where the upper body sinks, while inputting a subtraction of the force for maintaining the predetermined neutrality and the predetermined control amount mentioned above, into the actuator provided on the side where the upper body extends, it is possible to lighten the rolling of the upper body, thereby enabling running or traveling with stability. Also, with the rolling of high frequency exceeding a response capacity of the actuator, it is absorbed by the spring and the dumber, to be stabilized.

### Embodiment 2

Next, explanation will be made on a leg suspension of the robot, according to an embodiment 2.

Although the actuator 201L and the dumper 202L are connected in series in the embodiment 1, however in the embodiment 2, the actuator 201L and the dumper 202L are connected in parallel. With the parallel connection of the actuator 201L and the dumper 202L, it is possible to control an oscillation of a servo system of the actuator 201L, and thereby enabling to provide a more stable control.

Also, the control is executed in the similar manner to that of the embodiment 1, along the flowchart shown in FIG. 4.

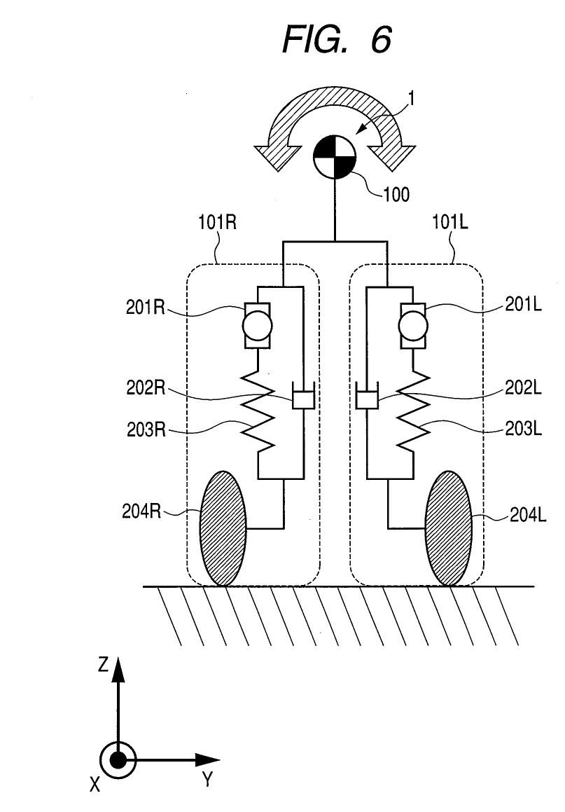

FIG. 6 is a diagram for showing the left shank (the part below the knee) 8 and the right shank (the part below the knee) 9 of a robot having the structures different from those of the robot shown in the embodiment 1. However, it is assumed that the robot 1 comprises the leg suspensions 101L and 101R on the respective leg portions on the left and the right sides thereof, as is shown in FIG. 5.

In FIG. 6, since the leg suspensions 101L and 101R are equal to each other in the constituent elements thereof and also the structures are symmetric with respect to the X-Z plane passing through the gravity center 100 of the robot, therefore explanation will be given only about the leg suspension 101L, hereinafter.

The leg suspension 101L, as is shown in the figure, has the wheel 204L, and above thereof is connected the spring 203L and the actuator 201L in series, and wherein the dumper 202L is connected with the spring 203L and the actuator 202L in parallel. Herein, the actuator 201L is attached in such direction that it outputs a force in the Z-axis direction, and operates in the similar manner to that described in the embodiment 1.

### Embodiment 3

Next, explanation will be given on the leg suspension of a robot, according to an embodiment 3.

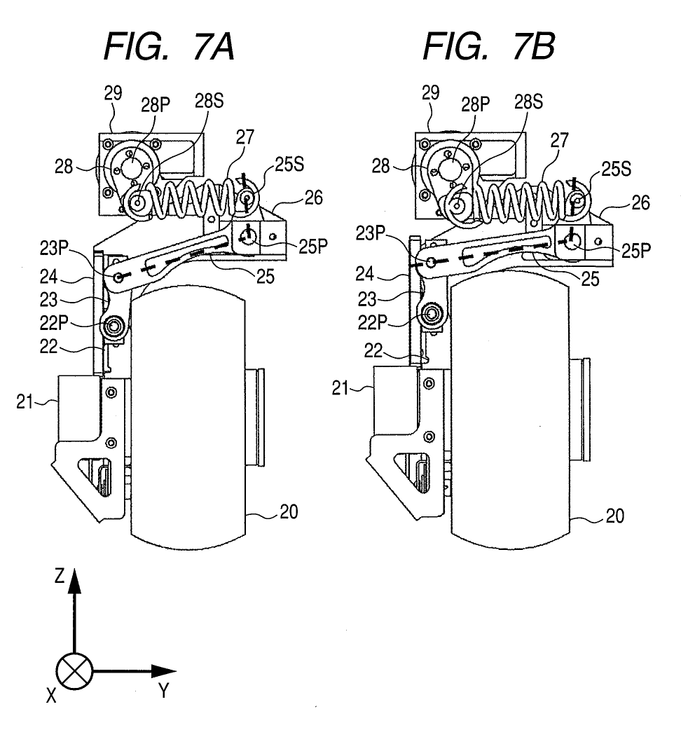

FIGS. 7A and 7B are views for showing an actual implementation condition of the leg suspension 101L of the robot 1, according to the embodiment 2.

For the purpose of increasing a capacity of absorption of the concave/convex on the road surface, it is necessary to lengthen the stroke of suspension; however in general, the spring comes to be large, there are many cases where it cannot be installed within a narrow space, such as, the leg portion of the robot. However, installing each of the elements in such construction as will be shown below, it is possible to install them even within the narrow space, such as, the leg portion of the robot.

The leg suspension 101L shown in FIG. 2 is attached on an upper end of a spring lower frame 22 to be rotatable only around the X-axis, together with the wheel 20, the wheel actuator 21 for driving this wheel, the spring lower frame 22 connected with the wheel actuator 21, a spring upper frame 26 connected through a slide rail 24 for allowing the degree of freedom only in the Z-axis direction between the spring lower frame 22, and an actuator 29 enabling to oscillate or swing an actuator lever 28 in the X-axis direction only by a predetermined angle, and being connected with the spring upper frame 26. Further, it is constructed with a first arm 23, which is connected to be rotatable around the X-axis with a second arm 25 at an opposite end in the longitudinal direction, the second arm 25, being connected at an end thereof to be rotatable around the X-axis together with the first arm 23, an opposite end thereof in the longitudinal direction being connected with the spring upper frame 26 to be rotatable around the X-axis, and being connected with a spring 27 at an end portion thereof extending by a predetermined angle, the spring 27 being connected with the second arm 25 at an end and connected with the actuator lever 28 at an opposite end in the longitudinal direction thereof, the actuator lever 28, being connected with the spring 27 at an end, and connected with an output shaft of the actuator 29 at an opposite end in the longitudinal direction thereof, and a dumper for connecting between the spring lower frame 22 and the spring upper frame 26, though not shown in the figure.

Herein, FIG. 7A shows a condition when the robot runs on the road surface, normally, and FIG. 7B is a view for showing a condition when the wheel receives a force from the road surface because of the convex portion on the road surface.

When the wheel 20 receives the force from the road surface in the Z-axis direction, the wheel 20, the wheel actuator 21 and the spring lower 22 moves, as a unit, in the Z-axis direction along the slide rail 24 as an unit. Accompanying this, the first arm turns around a center, a point 22P, and further at a point 23P, the second arm connected with the first arm 23 turns about a center, a point 25P, in the clockwise direction, thereby operating to pull up the spring 27, which is connected with the second arm 25 at a point 25S.

Herein, the spring 27 corresponds to the spring 203L shown in FIG. 5, and although the spring 203L is a compression spring within the construction shown in FIG. 5, but in FIG. 6, the force from the road surface is transferred to the spring 27 after converting it from a compression into a tension.

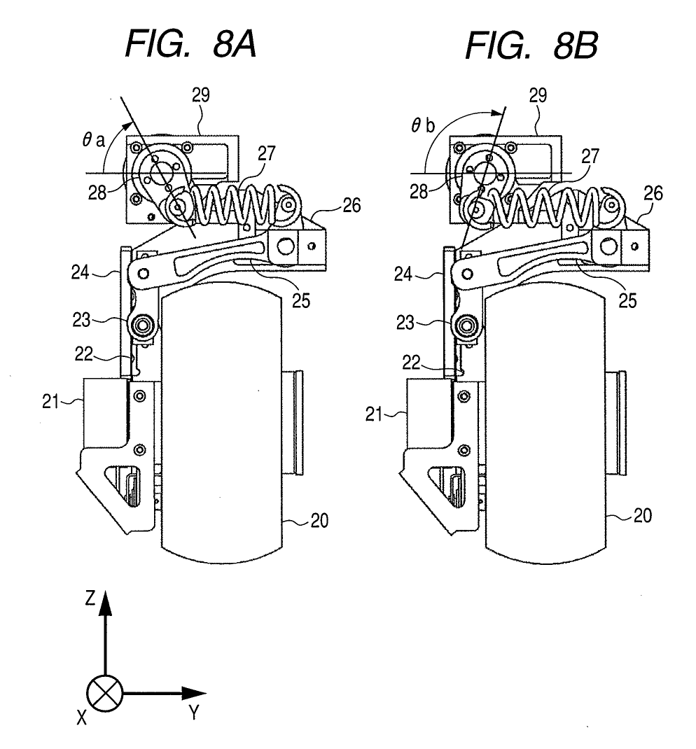

FIGS. 8A and 8B are views for explaining operations of the actuator 29, and in particular, FIG. 8A shows a condition where an angle defined by the actuator lever and the Y-axis is θa. FIG. 8B shows a condition where the angel defined by the actuator lever and the Y-axis is θb by turning the actuator lever around in the clockwise direction. Accordingly, the spring 27 is pulled up in a negative direction of Y-axis, and accompanying with that, the first arm 23 and the second arm 25 are rotated round, thereby generating a force for suppressing the wheel 20 onto the road surface.

Herein, the actuator lever 28 and the actuator 29 correspond to the actuator 201L shown in FIG. 5, and within the construction shown in FIG. 5, the actuator 201L has an output of expanding and constructing up and down. However, in FIG. 6, the actuator lever 28 is turned by the actuator 29, thereby control the distance between the point 25S and the point 28S, so as to input an operation force to the spring 17.

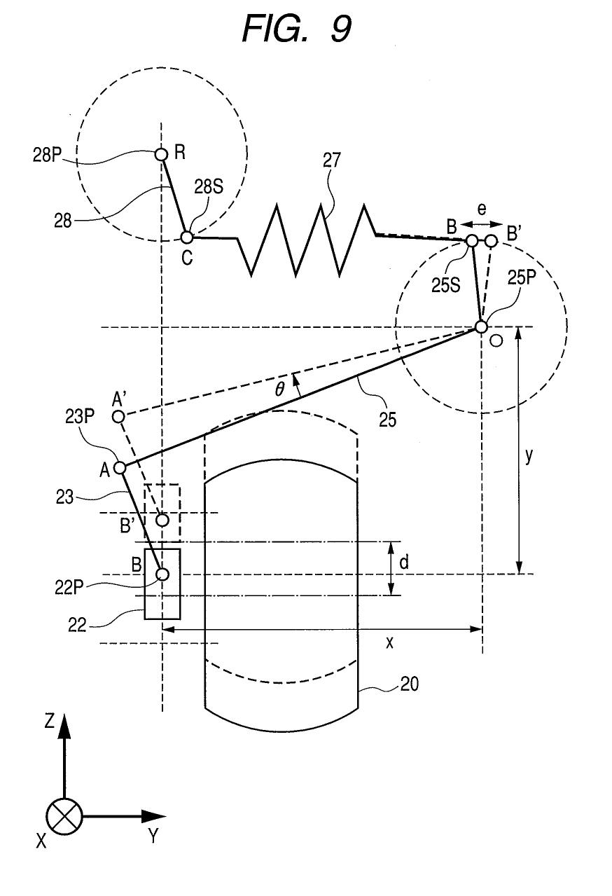

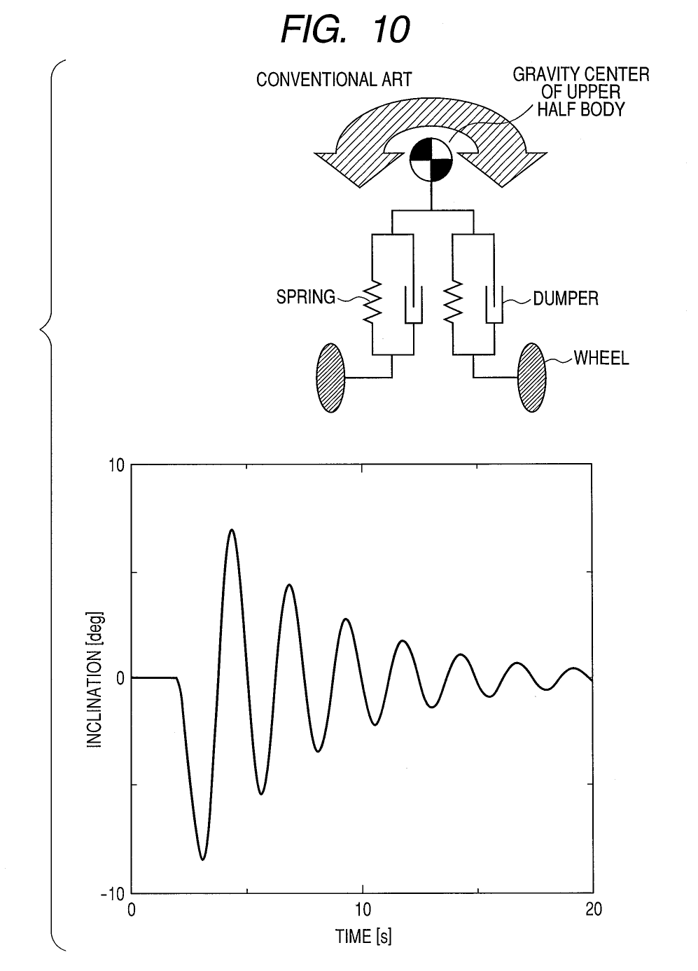

FIG. 9 is a view for explaining about the relationship of sizes, according to the present invention.

In FIG. 9, when the wheel 20 moves only by distance d from a neutral position, the spring lower frame 22 moves from an initial point B to a point B′ along the slide rail 24 (not shown in the present figure), and accompanying with that, the first arm 23 and the second arm 25 turn up to the position shown by a dotted line, wherein the point 25S, at which the spring 27 of the second arm 25 is attached, moves by “e”. Herein, “e” can be expressed by an equation shown below, (Equation 1):

$$e = OB ( {tan}^{- 1} ( \frac{x}{y - d} ) + {cos}^{- 1} ( \frac{{OA}^{2} + {x}^{2} + {( y - d )}^{2} - {AB}^{2}}{2 \cdot OA \sqrt{{x}^{2} + {( y - d )}^{2}}} ) - {tan}^{- 1} ( \frac{x}{y} ) - {cos}^{- 1} ( \frac{{OA}^{2} + {x}^{2} + {y}^{2} - {AB}^{2}}{2 \cdot OA \sqrt{{x}^{2} + {y}^{2}}} ) ) \qquad 〈 Equation 1 〉$$

Therefore, displacement of extension of spring/wheel can be expressed by the following equation.

$$h ≅ \frac{e}{d} \qquad 〈 Equation 2 〉$$

Stroke of the wheel 20 is determined by the maximum extension of the spring 27 from a natural length thereof, however if trying to keep the spring expansion to be large, there is a necessity of a long spring. Then, if determining “h” to be about “4”, for example, the extension of the spring 27 comes to “T/4 mm” when the wheel 20 strokes by “T mm”; therefore, it is enough that the spring 27 is short in the length thereof, and thereby enabling a compact installation.

Upon basis of such calculation mentioned above, it is possible to determine the springs and value of sizes thereof, which can be installed in the space of the leg, being narrow in a room of installation, and thereby achieving the compact suspension.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A robot, having left and right leg portions on a lower portion of a body, each of the legs comprising:
a wheel attached at a tip of said leg portion, to be drivable;
a suspension having a spring and a dumper, being attached in parallel, between said wheel and said body; and
an actuator, being attached between said suspension and said body, wherein
said suspension and said actuator are connected in series, and an inclination detecting means mounted on said body detects an inclination angle and an angular velocity of said robot with respect to a direction of gravity, and a control instruction value outputting means controls said actuator upon basis of information thereof, so that said robot travels along a target angle and a target angular velocity thereof.

2. The robot, as described in the claim 1, wherein
said spring is connected with an actuator expanding and constructing up and down, in series, and said dumper is provided in parallel with said spring and said actuator.

3. The robot, as described in the claim 1, further comprising:
an actuator for use of said wheel, a lower frame being connected with said actuator, a slide rail being connected with said lower frame, and an upper frame being connected with said slide rail, wherein said actuator is connected with said upper frame, and
being constructed with a first arm, being attached at an upper end of said lower frame to be rotatable only around an X-axis upon assumption that a traveling direction of said robot is said X-axis, and at an opposite end in a longitudinal direction thereof being connected with a second arm to be rotatable around said X-axis, said second arm, being connected with said first arm at one end to be rotatable around said X-axis, an opposite end in the longitudinal direction thereof being connected with said spring upper frame to be rotatable around said X-axis, and being connected with said spring at an end portion thereof extending by a predetermined angle, said spring being connected with said second arm at one end thereof, and being connected with said actuator lever at an opposite end in the longitudinal direction thereof, and said actuator lever being connected with said spring at an end thereof and being connected with an output axis of said actuator at an opposite end in the longitudinal direction thereof.
